(19) United States
(12) Patent Application Publication
(10) Pub. No.: US 2026/0149243 A1
(43) Pub. Date: May 28, 2026

(54) INTERLOCK ACCESSORY FOR ELECTRICAL VEHICLE (EV) APPLICATION

(71) Applicant: Siemens Industry, Inc., Alpharetta, GA (US)

(72) Inventor: Mario Munoz, Buford, GA (US)

(73) Assignee: Siemens Industry, Inc., Alpharetta, GA (US)

(21) Appl. No.: 18/961,913

(22) Filed: Nov. 27, 2024

(51) Int. Cl. H02B 1/20

(52) U.S. Cl. CPC H02B 1/20

(57) ABSTRACT

A residential electrical load center including an interlock accessory is configured to distribute electrical power to all different circuits by bus bars for an electrical vehicle (EV) application. The residential electrical load center comprises a main circuit breaker that is configured to protect the bus bars from potential overloads and or short circuits, a plurality of branch circuit breakers that are connected to the bus bars and are configured to protect individual circuits for each load of a plurality of loads and an interlock accessory that is configured to interlock two branch circuit breakers of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

### BACKGROUND

### 1. Field

Aspects of the present disclosure generally relate to an interlock accessory for an electrical vehicle application.

### 2. Description of the Related Art

A residential load center has a limited electrical current rating. For that reason, it is required to prevent the loads to exceed the load center electrical current rating.

With the wake of the electrical vehicle production, a new requirement is gradually increasing to install residential electrical charges for these vehicles. Although the ratings of these chargers keep increasing to reduce the charging time, the typical charger for overnight vehicle charging may be up to 60 A.

Per the National Electrical Code®, the number of circuits in a residential load center may not exceed the rated capacity of the load center. In several cases, the number of circuits are already maximized and without extra room to accommodate an additional circuit for an electrical vehicle charger. In these cases, a feasible option is to increase the capacity of the load center which requires to physically replace the existing load center with a new one. This option may be labor intensive and expensive.

Therefore, a way is needed to prevent the load center to be overloaded.

### SUMMARY

Briefly described, aspects of the present disclosure relate to a way to prevent a load center to be overloaded. An interlock accessory will turn off a targeted load (e. g., a clothes drier, a range, etc.) and turn on an electrical vehicle charger simultaneously and vice versa. This way, it prevents the load center to be overloaded.

A potential solution is to expand the size of the load center capacity to accommodate the added loads for electrical vehicle charger. This option is considered very expensive to install. The proposed interlock accessory is very inexpensive solution to select a load to be disconnected while the electrical charger is activated.

In accordance with one illustrative embodiment of the present disclosure, a residential electrical load center including an interlock accessory is configured to distribute electrical power to all different circuits by bus bars for an electrical vehicle (EV) application. The residential electrical load center comprises a main circuit breaker that is configured to protect the bus bars from potential overloads and or short circuits, a plurality of branch circuit breakers that are connected to the bus bars and are configured to protect individual circuits for each load of a plurality of loads and an interlock accessory that is configured to interlock two branch circuit breakers of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

In accordance with one illustrative embodiment of the present disclosure, a method of providing a residential electrical load center that distributes electrical power to all different circuits by bus bars is provided. The method comprises providing a main circuit breaker that is configured to protect the bus bars from potential overloads and or short circuits, providing a plurality of branch circuit breakers that are connected to the bus bars and are configured to protect individual circuits for each load of a plurality of loads, and providing an interlock accessory that is configured to interlock two branch circuit breakers of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 illustrates a schematic of an interlock accessory for an electrical vehicle application wherein a residential electrical load center that distributes electrical power to all different circuits by bus bars is coupled to a meter combo in accordance with an embodiment of the present disclosure.

FIG. 2 illustrates a schematic of an interlock accessory in accordance with an embodiment of the present disclosure.

FIG. 3 illustrates a schematic of a sliding lever motion and a stepper motor control of the interlock accessory of FIG. 2 in accordance with an embodiment of the present disclosure.

FIG. 4 illustrates a schematic of a residential electrical load center with 120/240V Phase “A” and 120/240V Phase “B” in accordance with an embodiment of the present disclosure.

FIG. 5 illustrates a schematic of parts included in a kit of an interlock accessory in accordance with an embodiment of the present disclosure.

FIG. 6 illustrates a perspective view of an interlock accessory in accordance with an embodiment of the present disclosure.

FIG. 7 illustrates a perspective view of a motorized assembly of an interlock accessory in accordance with an embodiment of the present disclosure.

FIG. 8 shows a flow chart for a method of providing an interlock accessory in a residential electrical load center that distributes electrical power to all different circuits by bus bars according to an embodiment of the present disclosure.

### DETAILED DESCRIPTION

Various technologies pertain to an interlock accessory for an electrical vehicle application for use in a residential electrical load center. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present disclosure, they are explained hereinafter with reference to implementation in illustrative embodiments. In particular, they are described in the context of an interlock accessory for an electrical vehicle application for use in a residential electrical load center of a meter combo. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

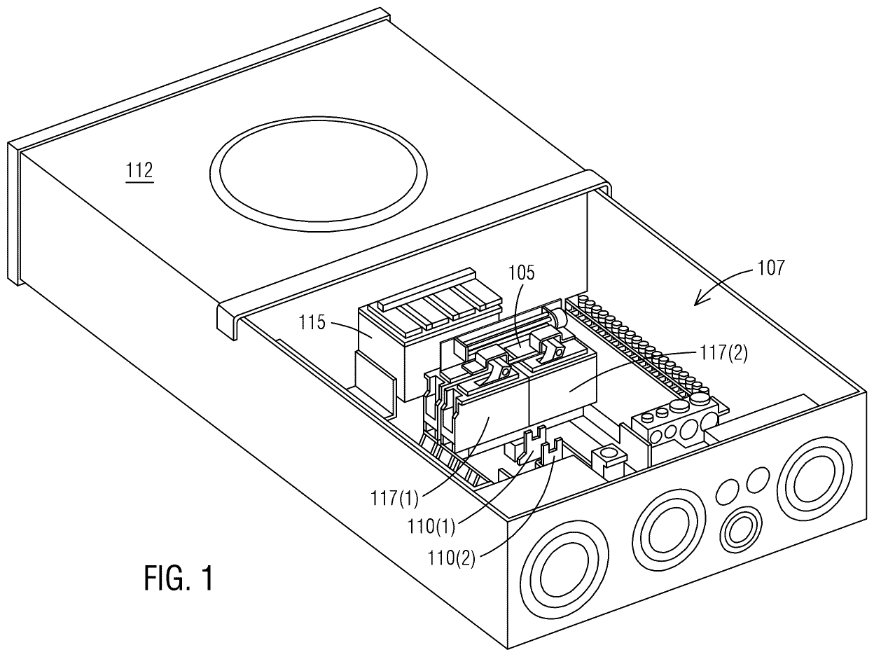

These and other embodiments of the interlock accessory according to the present disclosure are described below with reference to FIG. 1 herein. The drawing is not necessarily drawn to scale.

Consistent with an embodiment of the present disclosure, FIG. 1 represents a schematic of an interlock accessory 120 for an electrical vehicle application wherein a residential electrical load center 107 that distributes electrical power to all different circuits by bus bars 110(1-2) is coupled to a meter combo 112 in accordance with an embodiment of the present disclosure. A typical residential electrical load center is typically rated 120/240 V.

In one embodiment, the residential electrical load center 107 comprises a main circuit breaker 115 that is configured to protect the bus bars 110(1-2) from potential overloads and or short circuits. The residential electrical load center 107 further comprises a plurality of branch circuit breakers 117(1-2) that are connected to the bus bars 110(1-2) and are configured to protect individual circuits for each load of a plurality of loads. The residential electrical load center 107 further comprises the interlock accessory 120 that is configured to interlock two branch circuit breakers 117(1-2) of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

The two branch circuit breakers 117(1-2) of the plurality of branch circuit breakers may supply two different circuits. It is critical that both branch circuit breakers 117(1-2) may not be “ON” at the same time to avoid overloading the residential electrical load center 107. The interlock accessory 120 may be manually operated to select a desired circuit.

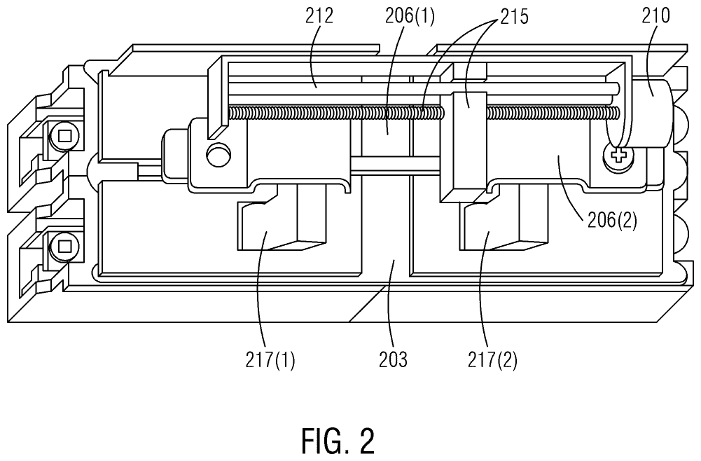

The interlock accessory 120 is intended to allow only one of the two breakers to be in the “ON” position. The action of pushing sliding plates (see FIG. 2) of the interlock accessory 120 in the opposite direction will allow the line to be in the “ON” position while the other will be in the “OFF” position.

Referring to FIG. 2, it illustrates a top view of the interlock accessory 120 in accordance with an embodiment of the present disclosure. The interlock accessory 120 comprises a mounting plate 203, sliding plates 206(1-2), a stepper motor 210, rod guides 212 and a screwdriver and sliding lever 215. Braker's handles 217(1-2) are also visible.

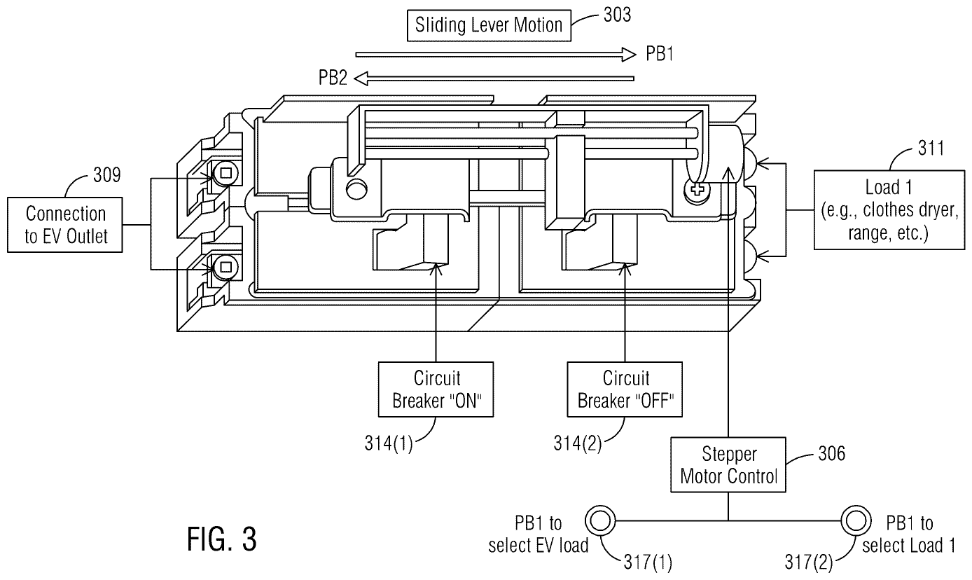

Turning now to FIG. 3, it illustrates a schematic of a sliding lever motion (PB1, PB2 arrows) 303 and a stepper motor control 306 of the interlock accessory 120 of FIG. 2 in accordance with an embodiment of the present disclosure. A connection to an electric vehicle (EV) outlet 309 is also shown. On the opposite side, a “Load 1” connection 311 is also shown. A circuit breaker “ON” position 314(1) and a circuit breaker “OFF” position 314(2) are also shown. PB1 to select E.V. load at 317(1) and PB1 to select Load 1 at 317(2).

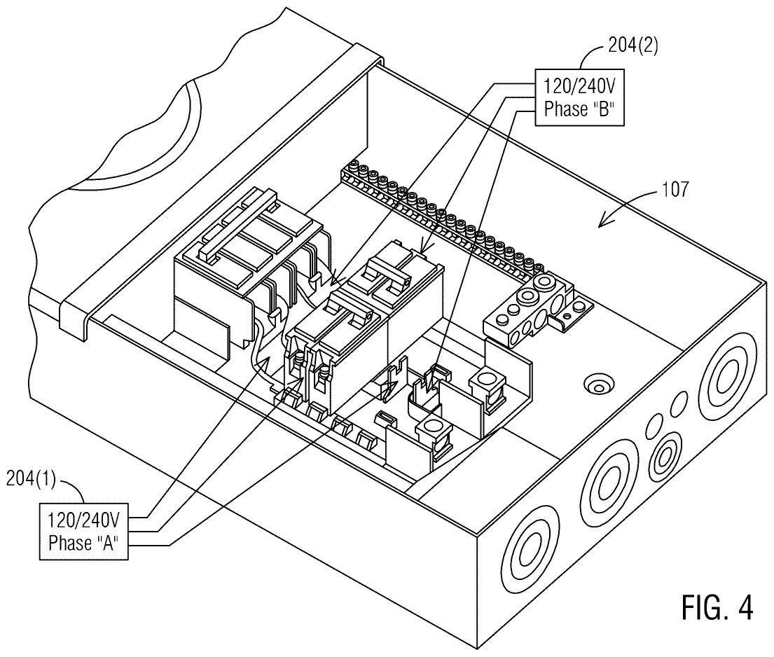

FIG. 4 illustrates a schematic of the residential electrical load center 107 with 120/240V Phase “A” 204(1) and 120/240V Phase “B” 204(2) in accordance with an embodiment of the present disclosure. 120/240 on the breakers means that the breaker is permitted to serve either a 120 volt load or, in combination with another breaker, a 240 volt load. If you measure from hot wire to hot wire you will get 240 volts and if you measure from either hot wire to neutral you will get 120 volts.

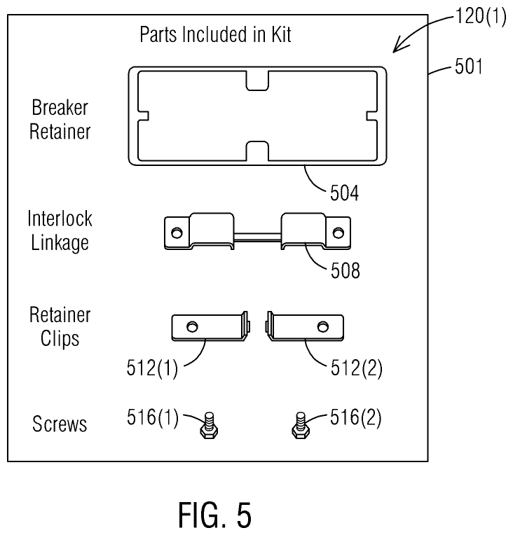

As seen in FIG. 5, it illustrates a schematic of parts included in a kit 501 of an interlock accessory 120(1) in accordance with an embodiment of the present disclosure. The interlock accessory 120(1) comprises a beaker retainer 504, an interlock linkage 508 with a standby side and a utility side, first and second retainer clips 512(1-2) and first and second screws 516(1-2) to secure the interlock linkage 508 with the first and second retainer clips 512(1-2).

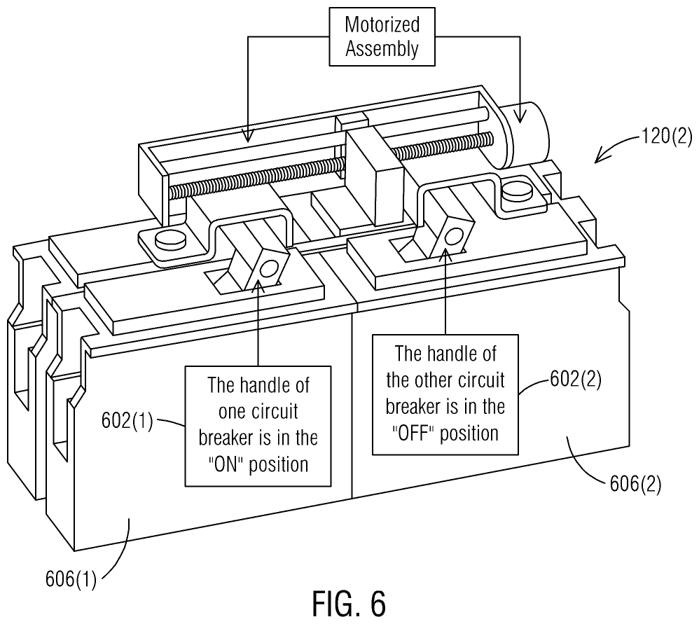

As shown in FIG. 6, it illustrates a perspective view of an interlock accessory 120(2) in accordance with an embodiment of the present disclosure. A handle 602(1) of one branch circuit breaker 606(1) is in the “ON” position and a handle 602(2) of other branch circuit breaker 606(2) is in the “OFF” position. The interlock accessory 120(2) is physically blocking one branch circuit breaker's handle to prevent it from moving to an “ON” position while the other branch circuit breaker is powered. A complete interlock accessory assembly is installed onto the two branch circuit breakers of the plurality of branch circuit breakers.

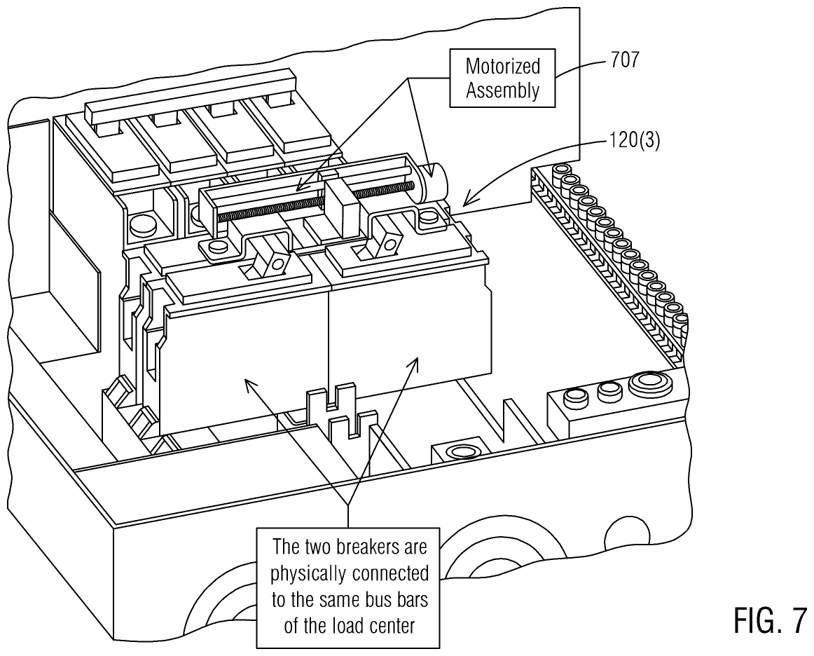

In FIG. 7, it illustrates a perspective view of a motorized assembly 707 of an interlock accessory 120(3) in accordance with an embodiment of the present disclosure. The interlock accessory 120(3) comprises the motorized assembly 707 added to a mounting plate of the interlock accessory 120(3) such that the motorized assembly 707 may enable the interlock accessory 120(3) to be remotely operated with push buttons to select a desired circuit.

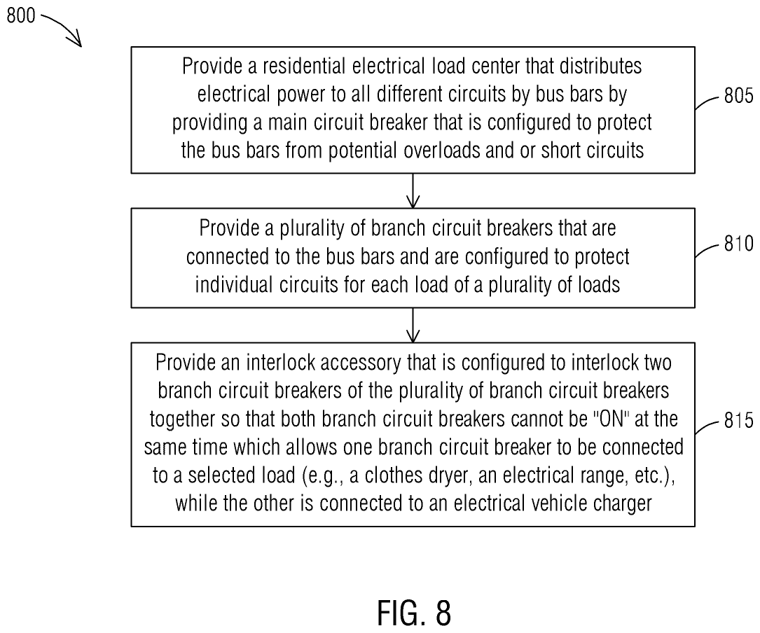

With regard to FIG. 8, it shows a flow chart for a method 800 of providing an interlock accessory in a residential electrical load center that distributes electrical power to all different circuits by bus bars according to an embodiment of the present disclosure. Reference is made to the elements and features described in FIGS. 1-7. It should be appreciated that some steps are not required to be performed in any particular order, and that some steps are optional.

The method 800 comprises a step 805 of providing a residential electrical load center that distributes electrical power to all different circuits by bus bars by providing a main circuit breaker that is configured to protect the bus bars from potential overloads and or short circuits. The method 800 further comprises a step 810 of providing a plurality of branch circuit breakers that are connected to the bus bars and are configured to protect individual circuits for each load of a plurality of loads. The method 800 further comprises a step 815 of providing an interlock accessory that is configured to interlock two branch circuit breakers of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

An interlock accessory for an electrical vehicle option may turn off the circuit breaker that feeds a load that is sporadically utilized (e. g., clothes drier) and simultaneously turn on a circuit breaker that may feed an EV charger. When the need arises to utilize the selected load, the interlock accessory may be operated to reverse the circuit breakers operation by turning the EV breaker off and the selected load on. This option may prevent the load center from being overloaded with these alternate loads operating simultaneously.

The interlock accessory operation may be manually operated. Alternatively, the operation may be done electronically with push buttons to select the position of the interlock accessory. Also, an app may be developed so the interlock accessory may be remotely operated (e. g., Bluetooth, wi-fi, etc.).

The electronic operation of the interlock accessory may require a mechanism that is controlled by an electronic circuit that can operate a small stepper motor. This motor may rotate a screw that causes a sliding lever to move and automatically position the interlock accessory in the desired position. The sliding lever is guided by two steel rods that maintain the sliding lever on a defined moving trajectory. These components are installed on a metal frame that may be mounted on a wall of the interlock accessory.

The meter combo is an example. An application of the interlock accessory is for Electrical Vehicle charger installation. The proposed interlock assembly may be applicable and installed in any of many existing load centers.

While a residential electrical load center of a meter combo based on an electrical vehicle application is disclosed, other number of combinations or partial combinations are also possible. For example, other platforms may be implemented based on one or more features presented above without deviating from the spirit of the present disclosure.

The techniques described herein can be particularly useful for an electrical vehicle (EV) application. While particular embodiments are described in terms of an electrical vehicle (EV) application, the techniques described herein are not limited to such applications.

While embodiments of the present disclosure have been disclosed in exemplary forms, it will be apparent to those skilled in the art that many modifications, additions, and deletions can be made therein without departing from the spirit and scope of the disclosure and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the disclosure has been described with reference to specific embodiments. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of disclosure.

Although the disclosure has been described with respect to specific embodiments thereof, these embodiments are merely illustrative, and not restrictive of the disclosure. The description herein of illustrated embodiments of the disclosure is not intended to be exhaustive or to limit the disclosure to the precise forms disclosed herein (and in particular, the inclusion of any particular embodiment, feature or function is not intended to limit the scope of the disclosure to such embodiment, feature or function). Rather, the description is intended to describe illustrative embodiments, features and functions in order to provide a person of ordinary skill in the art context to understand the disclosure without limiting the disclosure to any particularly described embodiment, feature or function. While specific embodiments of, and examples for, the disclosure are described herein for illustrative purposes only, various equivalent modifications are possible within the spirit and scope of the disclosure, as those skilled in the relevant art will recognize and appreciate. As indicated, these modifications may be made to the disclosure in light of the foregoing description of illustrated embodiments of the disclosure and are to be included within the spirit and scope of the disclosure. Thus, while the disclosure has been described herein with reference to particular embodiments thereof, a latitude of modification, various changes and substitutions are intended in the foregoing disclosures, and it will be appreciated that in some instances some features of embodiments of the disclosure will be employed without a corresponding use of other features without departing from the scope and spirit of the disclosure as set forth. Therefore, many modifications may be made to adapt a particular situation or material to the essential scope and spirit of the disclosure.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the disclosure.

In the description herein, numerous specific details are provided, such as examples of components and/or methods, to provide a thorough understanding of embodiments of the disclosure. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the disclosure. While the disclosure may be illustrated by using a particular embodiment, this is not and does not limit the disclosure to any particular embodiment and a person of ordinary skill in the art will recognize that additional embodiments are readily understandable and are a part of this disclosure.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A residential electrical load center that distributes electrical power to all different circuits by bus bars, the residential electrical load center comprising:
a main circuit breaker that is configured to protect the bus bars from potential overloads and or short circuits;
a plurality of branch circuit breakers that are connected to the bus bars and are configured to protect individual circuits for each load of a plurality of loads; and
an interlock accessory that is configured to interlock two branch circuit breakers of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

2. The residential electrical load center of claim 1, wherein the interlock accessory comprising:
a beaker retainer;
an interlock linkage with a standby side and a utility side;
first and second retainer clips; and
first and second screws to secure the interlock linkage with the first and second retainer clips.

3. The residential electrical load center of claim 1, wherein two branch circuit breakers of the plurality of branch circuit breakers may supply two different circuits.

4. The residential electrical load center of claim 1, wherein it is critical that both branch circuit breakers may not be “ON” at the same time to avoid overloading the residential electrical load center.

5. The residential electrical load center of claim 1, wherein the interlock accessory may be manually operated to select a desired circuit.

6. The residential electrical load center of claim 1, wherein an action of pushing sliding plates of the interlock accessory in an opposite direction will allow line to be in “ON” position while the other will be in “OFF” position.

7. The residential electrical load center of claim 6, wherein a handle of one branch circuit breaker is in the “ON” position and a handle of other branch circuit breaker is in the “OFF” position.

8. The residential electrical load center of claim 1, wherein the interlock accessory comprises a motorized assembly added to a mounting plate of the interlock accessory such that the motorized assembly may enable the interlock accessory to be remotely operated with push buttons to select a desired circuit.

9. The residential electrical load center of claim 8, wherein the interlock accessory is physically blocking one branch circuit breaker's handle to prevent it from moving to an “ON” position while the other branch circuit breaker is powered.

10. The residential electrical load center of claim 1, wherein a complete interlock accessory assembly is installed onto the two branch circuit breakers of the plurality of branch circuit breakers.

11. A method of providing a residential electrical load center that distributes electrical power to all different circuits by bus bars, the method comprising:
providing a main circuit breaker that is configured to protect the bus bars from potential overloads and or short circuits;
providing a plurality of branch circuit breakers that are connected to the bus bars and are configured to protect individual circuits for each load of a plurality of loads; and
providing an interlock accessory that is configured to interlock two branch circuit breakers of the plurality of branch circuit breakers together so that both branch circuit breakers cannot be “ON” at the same time which allows one branch circuit breaker to be connected to a selected load (e.g. a clothes drier, an electrical range, etc.), while the other is connected to an electrical vehicle charger.

12. The method of claim 11, wherein the interlock accessory comprising:
a beaker retainer;
an interlock linkage with a standby side and a utility side;
first and second retainer clips; and
first and second screws to secure the interlock linkage with the first and second retainer clips.

13. The method of claim 11, wherein two branch circuit breakers of the plurality of branch circuit breakers may supply two different circuits.

14. The method of claim 11, wherein it is critical that both branch circuit breakers may not be “ON” at the same time to avoid overloading the residential electrical load center.

15. The method of claim 11, wherein the interlock accessory may be manually operated to select a desired circuit.

16. The method of claim 11, wherein an action of pushing sliding plates of the interlock accessory in an opposite direction will allow line to be in “ON” position while the other will be in “OFF” position.

17. The method of claim 16, wherein a handle of one branch circuit breaker is in the “ON” position and a handle of other branch circuit breaker is in the “OFF” position.

18. The method of claim 11, wherein the interlock accessory comprises a motorized assembly added to a mounting plate of the interlock accessory such that the motorized assembly may enable the interlock accessory to be remotely operated with push buttons to select a desired circuit.

19. The method of claim 18, wherein the interlock accessory is physically blocking one branch circuit breaker's handle to prevent it from moving to an “ON” position while the other branch circuit breaker is powered.

20. The method of claim 11, wherein a complete interlock accessory assembly is installed onto the two branch circuit breakers of the plurality of branch circuit breakers.
